(19) United States
(12) Patent Application Publication
(10) Pub. No.: US 2026/0356439 A1
(43) Pub. Date: Nov. 12, 2026

(54) MOTOR VEHICLE REAR TRAIN ATTACHED BY A CUBIC SPACER TO THE INSIDE OF THE LONGITUDINAL MEMBER

(71) Applicant: STELLANTIS AUTO SAS, Poissy (FR)

(72) Inventors: Quentin GIRAUDON, Brognard (FR); Eddy Fournaise, Arcey (FR); Laurent Arnaud, Senargent Mignafans (FR)

(21) Appl. No.: 19/135,205

(22) PCT Filed: Nov. 7, 2023
(86) PCT No.: PCT/FR2023/051745

§ 371 Date: Jun. 3, 2025

(30) Foreign Application Priority Data
Dec. 9, 2022 (FR) 2213045

(51) Int. Cl. B62D 27/06

(52) U.S. Cl. CPC B62D 27/065

(57) ABSTRACT

The invention relates to a motor vehicle comprising:-a chassis comprising a rear part with two profiles (6) extending longitudinally and parallel to each other;—a rear train comprising a cradle rigidly attached to each of the two profiles, characterized in that at least one attachment of the cradle to one of the profiles comprises a screw passing through the profile and engaging with a spacer (16) inside the profile and a nut (18) inside the profile, the spacer being arranged between, and against, a bottom wall (6.1) of the profile and a reinforcing tab (20), the nut being against said reinforcing tab opposite said spacer.

### CROSS-REFERENCE TO RELATED APPLICATIONS

This application is the US National Stage under 35 USC § 371 of International Application No. PCT/FR2023/051745, filed Nov. 7, 2023, which claims the priority of the French application 2213045 filed on Dec. 9, 2022, the content (text, drawings and claims) of both said applications being incorporated by reference herein.

### BACKGROUND

The described devices relate to the field of motor vehicles, more particularly to the field of motor vehicle chassis.

Motor vehicles have a rear train which is generally attached to a rear part of the body, and specifically attached to rear side rails, commonly referred to as “longitudinal members”. The latter comprise a usually restricted environment to accommodate the attachment with the rear train.

In this configuration, the attachment of the rear train to the longitudinal members must be sufficiently compact and rigid to absorb any rear impacts on the chassis of the motor vehicle.

Published patent document FR 3 105 153 A1 discloses a structure for the rear part of a motor vehicle body, comprising a rear train attached by means of attachment members presented, respectively, at right angles to the side rails and at right angles to the longitudinal members arranged transversely at a distance from said side rails.

However, the solution proposed by the document requires the use of bulky reinforcements in the area of the attachment members, both in the side rails and the longitudinal members, in order to stiffen the attachment. Such a configuration makes rear train assembly more complex and heavier, and therefore more expensive.

### SUMMARY

The purpose is to overcome at least one of the disadvantages of the aforementioned prior art. More specifically, the aim is to provide a simple, high-performance and cost-effective solution for ensuring optimum attachment of the rear train to the structure of the motor vehicle, and guaranteeing the durability of said rear train attachment, in a compact environment and without increasing the mass of the assembly.

To this end, related herein is a motor vehicle comprising:
a chassis comprising a rear part with two profiles extending longitudinally and parallel to each other;
a rear train comprising a cradle rigidly attached to each of the two profiles, characterized in that at least one attachment of the cradle to one of the profiles comprises a screw passing through the profile and engaging with a spacer inside the profile and a nut inside the profile, the spacer being arranged between, and against, a bottom wall of the profile and a reinforcing tab, the nut being against said reinforcing tab opposite said spacer.

According to one embodiment, the spacer is rigidly attached to the bottom wall, preferentially by welding.

According to one embodiment, the motor vehicle further comprising a reinforcement forming a profile with a cross section in the form of an angle bracket, with a first wall between the bottom wall and a front face of the spacer and a second wall attached against a side face of the spacer.

According to one embodiment, the side face of the spacer is flat.

According to one embodiment, the nut is housed in a cage attached to the reinforcing tab, preferentially by clipping.

According to one embodiment, the reinforcing tab forms an angle bracket with a vertical wall attached against a side wall of the profile, and a horizontal wall between the spacer and the nut.

According to one embodiment, the reinforcement extends longitudinally along a length greater than or equal to a total longitudinal extent of the reinforcing tab and less than or equal to twice said total longitudinal extent of the reinforcing tab.

According to one embodiment, the spacer is attached to a central part of the extent of the reinforcement.

According to one embodiment, the at least one attachment comprises two attachments forming a left rear attachment point and a right rear attachment point of the cradle on each of the two profiles, respectively.

Also related herein is a hollow, closed-section profile for a motor vehicle chassis, comprising a hole intended to receive an attachment screw, characterized in that the profile comprises a reinforcement attached to a bottom wall of the profile, a spacer located in the profile, a reinforcing tab attached to the profile, and a nut bearing on the reinforcing tab and located in the profile, said nut being housed in a cage attached to the reinforcing tab, said spacer comprising a side face attached to a vertical wall of the reinforcement.

Attaching the cradle of the rear train to the profiles of the motor vehicle ensures optimum, lightweight and compact attachment. In fact, the reinforcement extends longitudinally in an optimized manner, thus minimizing the total weight of the profile and reducing the associated costs.

The spacer, which is welded to the reinforcement and bears on the reinforcing tab, ensures the durability of the attachment of the rear train to the structure of the motor vehicle.

### BRIEF DESCRIPTION OF THE DRAWINGS

FIG. 1 depicts a bottom perspective view of a motor vehicle;

FIG. 2 depicts a perspective view of a hollow-section profile of a rear part of the chassis of the vehicle of FIG. 1;

FIG. 3 depicts a perspective view of a nut housed in a cage intended to be attached to a reinforcing tab mounted on the profile of FIG. 2.

### DETAILED DESCRIPTION

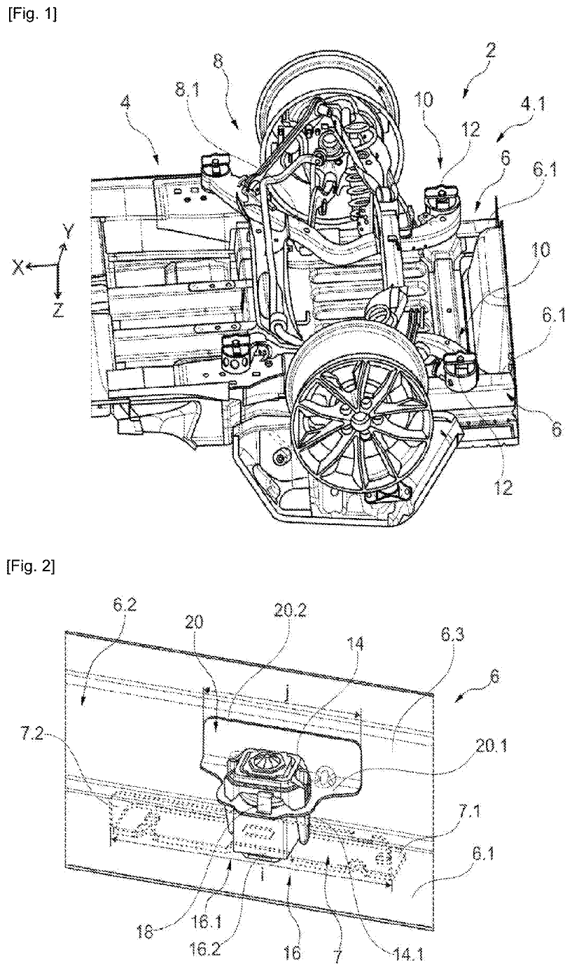

FIG. 1 depicts a bottom perspective view of a motor vehicle 2.

The motor vehicle 2 comprises a chassis 4 having a rear part 4.1 with two profiles 6, commonly referred to as “longitudinal members,” extending longitudinally and parallel to each other.

It can be seen that a rear train 8 having a cradle 8.1 rigidly attached to each of the two profiles 6. In this configuration, the cradle 8.1 preferentially comprises two rear attachment points 10 corresponding to a right rear attachment point and a left rear attachment point.

Each profile 6 comprises a bottom wall 6.1 through which an attachment 10 screw 12 passes. In this respect, the bottom wall 6.1 comprises a hole (not shown) intended to receive the screw 12.

FIG. 2 depicts a perspective view of the profile 6 of the rear part 4.1 of the chassis 4 of the motor vehicle 2 of FIG. 1.

A closed, hollow section 6.2 of the profile 6 can be seen. Preferentially, each of the two profiles 6 of the motor vehicle comprises a U-shaped hollow section.

In this configuration, the hollow part 6.2 of the profile 6 is delimited, in the vertical direction Z shown in FIG. 1, by the bottom wall 6.1. The latter comprises a reinforcement 7 forming cross sectional profile in the form of an angle bracket extending in the longitudinal direction.

The screw 12 of the attachment 10 shown in FIG. 1 extends vertically into the profile 6, passing successively through: the bottom wall 6.1, the reinforcement 7, a spacer 16 arranged inside the profile 6, a reinforcing tab 20 and a nut arranged against said reinforcing tab 20.

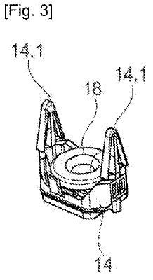

The spacer 16 is sandwiched between the reinforcing tab 20 and the reinforcement 7. In this respect, the reinforcement 7 comprises a first wall 7.1 attached by welding to the bottom wall 6.1 of the profile 6, and the tab 20 comprises a horizontal wall 20.1 arranged between the spacer 16 and the nut 18 visible in FIG. 3.

FIG. 3 depicts a perspective view of the nut 18 housed in a cage 14 designed to be attached to the reinforcing tab 20.

Referring to FIGS. 2 and 3, the cage 14 is preferably a plastic part used to hold the nut 18 on the tab 20.

In this respect, the cage 14 advantageously comprises two V-shaped clips 14.1 intended to pass through the reinforcing tab to ensure effective retention of the nut 18. The clips 14.1, which extend vertically toward the bottom wall 6.1, further serve to hold the spacer 16 in position and limit its movements in the hollow part 6.2 prior to attachment of the assembly by means of the screw. In this configuration, the screw 12 of the attachment 10 shown in FIG. 1 passes completely and vertically through the spacer 16, nut 18 and cage 14.

Preferentially, the tab 20 forms an angle bracket with, additionally, a vertical wall 20.2 directly attached to a side wall 6.3 of the profile 6.

The spacer 16 comprises a front face 16.1 which bears against the first wall 7.1 of the reinforcement 7. The latter also comprising a second wall 7.2 attached against a side face 16.2 of the spacer 16. Preferentially, the second wall 7.2 extends perpendicularly to the first wall 7.1.

In this respect, the spacer 16 preferentially comprises a rectangular parallelepiped shape. More preferentially, the spacer 16 comprises a cubic shape. Thus, the side face 16.2 of the spacer 16 is flat.

Preferably, the spacer 16 is rigidly welded to the first 7.1 and second 7.2 walls of the reinforcement 7. In this configuration, a weld bead can be placed at each junction between the side faces of the spacer 16 and the walls 7.1, 7.2 of the reinforcement 7.

Advantageously, the vertical bearing of the spacer 16 against the reinforcing tab 20 and its rigid attachment to the reinforcement 7 enables improved resistance of the assembly against axial and radial forces, and thus ensures good endurance of the rear train attachment to the structure of the motor vehicle.

The reinforcement 7 extends longitudinally along a length i greater than or equal to a total longitudinal extent j of the reinforcing tab 20 and less than or equal to twice said total longitudinal extent j of the tab 20.

Preferentially, the length i of the reinforcement 7 is between 40 mm and 200 mm. The spacer 16 is attached in line with a central part of the extent i of the reinforcement 7.

Advantageously, the reinforcement 7 extends longitudinally in the profile 6 in an optimized manner, minimizing the total mass of said profile 6 and thus that of the motor vehicle, resulting in a reduction in associated costs.

The profile 6 enables the cradle of the rear train to be attached to the motor vehicle efficiently, with the nut bearing firmly on the reinforcing tab, guaranteeing good endurance of the attachment, by means of an optimized reinforcement, thus guaranteeing lightness in the assembly of the motor vehicle.

1. A motor vehicle comprising:
a chassis comprising a rear part with two profiles extending longitudinally and parallel to each other;
a rear train comprising a cradle rigidly attached to each of the two profiles,
wherein at least one attachment of the cradle to one of the profiles comprises a screw passing through the profile and engaging with a spacer inside the profile and a nut inside the profile, the spacer being arranged between, and against, a bottom wall of the profile and a reinforcing tab, the nut being against said reinforcing tab opposite said spacer.

2. The motor vehicle according to claim 1, wherein the spacer is rigidly attached to the bottom wall, preferentially by welding.

3. The motor vehicle according to claim 2, further comprising a reinforcement forming a profile with a cross section in the form of an angle bracket, with a first wall between the bottom wall and a front face of the spacer and a second wall attached against a side face of the spacer.

4. The motor vehicle according to claim 3, wherein the side face of the spacer is flat.

5. The motor vehicle according to claim 1, wherein the nut is housed in a cage attached to the reinforcing tab, preferentially by clipping.

6. The motor vehicle according to Claim 1, wherein the reinforcing tab forms an angle bracket with a vertical wall attached against a side wall of the profile, and a horizontal wall between the spacer and the nut.

7. The motor vehicle according to claim 3, wherein the reinforcement longitudinally along a length greater than or equal to a total longitudinal extent of the reinforcing tab and less than or equal to twice said total longitudinal extent of the reinforcing tab.

8. The motor vehicle according to claim 7, wherein the spacer is attached in line with a central part of the extent of the reinforcement.

9. The motor vehicle according to claim 1, wherein the at least one attachment comprises two attachments forming a left rear attachment point and a right rear attachment point of the cradle on each of the two profiles, respectively.

10. A hollow, closed-section profile for a motor vehicle chassis, comprising a hole intended to receive an attachment screw, wherein the profile comprises a reinforcement attached to a bottom wall of the profile, a spacer located in the profile, a reinforcing tab attached to the profile, and a nut bearing on the reinforcing tab and located in the profile, said nut being housed in a cage attached to the reinforcing tab, said spacer comprising a side face attached to a vertical wall of the reinforcement.
